(19) United States
(12) Patent Application Publication
(10) Pub. No.: US 2026/0199869 A1
(43) Pub. Date: Jul. 16, 2026

(54) METAL ION ADSORPTION AND IMMOBILIZATION BY CARBON-COATED OIL-TREATED PLASTIC GRANULES

(71) Applicants: Elham Fini, Phoenix, AZ (US); Farideh Pahlavan, Chandler, AZ (US)

(72) Inventors: Elham Fini, Phoenix, AZ (US); Farideh Pahlavan, Chandler, AZ (US)

(21) Appl. No.: 19/444,687

(22) Filed: Jan. 9, 2026

Related U.S. Application Data
(60) Provisional application No. 63/743,825, filed on Jan. 10, 2025.

(51) Int. Cl. B01J 20/20; B01J 20/28; B01J 20/30; B01J 20/32; C02F 1/28; C02F 101/20; C02F 101/30

(52) U.S. Cl. CPC B01J 20/20; B01J 20/2803; B01J 20/3021; B01J 20/3071; B01J 20/3085; B01J 20/3212; B01J 20/3223; B01J 20/324; B01J 20/3293; C02F 1/288; C02F 1/283; C02F 1/285; C02F 2101/20; C02F 2101/203; C02F 2101/308

(57) ABSTRACT

Treating plastic particles include combining waste bio-oil and a multiplicity of plastic particles, thereby forming a multiplicity of bio-oil-coated plastic particles; combining biochar and the multiplicity of bio-oil-coated plastic particles in an aqueous solution to yield a mixture including a multiplicity of biochar-coated plastic particles; and separating the multiplicity of biochar-coated plastic particles from the mixture to yield a multiplicity of treated plastic particles. Treating wastewater includes contacting the multiplicity of biochar-coated plastic particles with wastewater including metal ions and adsorbing the metal ions onto the multiplicity of biochar-coated plastic particles, thereby reducing a concentration of the metal ions in the wastewater.

### CROSS-REFERENCE TO RELATED APPLICATION

This application claims the benefit of U.S. Patent Application No. 63/743,825 filed on Jan. 10, 2025, which is incorporated by reference herein in its entirety.

### STATEMENT OF GOVERNMENT SUPPORT

This invention was made with government support under 1935723 awarded by the National Science Foundation. The government has certain rights in the invention.

### TECHNICAL FIELD

This invention relates to the development of carbon-coated oil-treated plastic granules (e.g., biochar-coated oil-treated plastic granules) for metal recovery and metal immobilization.

### BACKGROUND

Biochar is a carbon-rich material produced through the thermochemical decomposition of biomass under limited or no oxygen. Biochar offers a combination of high surface area, porosity, substantial cation and anion exchange capacity, and functional groups, including hydroxyl, carboxyl, and amine groups.

### SUMMARY

This disclosure describes the use of biochar derived from biomass to produce carbon-coated oil-treated plastic granules for metal recovery and metal immobilization from aqueous solutions. By combining density functional theory calculations, continuous-flow adsorption assessments, and ultraviolet-visible (UV-Vis) spectroscopy, the adsorption performance and underlying mechanisms of carbon-coated oil-treated plastic granules for metal ions (e.g., mercury, nickel, lead, chromium, iron, copper, cadmium, zinc, or a combination thereof) are assessed. Density functional theory analysis suggests that the biochar's surface functional groups (including oxygen- and nitrogen-containing sites) can facilitate complexation and ion exchange, enhancing metal-ion adsorption and immobilization.

The carbon-coated oil-treated plastic granules can be used as a filtration media for wastewater treatment and metal recovery. Wastewater can include organic pollutants, dyes, and metal ions. Metal ions in wastewater can include one or more of mercury, nickel, lead, chromium, iron, copper, cadmium, or zinc. This carbon-coated oil-treated plastic granules can be integrated into copper-mining operations to enhance copper recovery from wastewater, contributing to resource management and reducing the environmental impact. The carbon-coated oil-treated plastic granules can also be used for metal ion immobilization and metal recovery from contaminated water sources, including but not limited to acid mine drainage, wastewater from electronic waste processing, semiconductor manufacturing effluences, and municipal water treatment facilities. For metal ion immobilization, the carbon-coated oil-treated granules can be incorporated into permeable composites such as concrete, asphalt, geopolymer, and ceramics.

In a first general aspect, treating plastic particles include combining waste bio-oil and a multiplicity of plastic particles, thereby forming a multiplicity of bio-oil-coated plastic particles, combining biochar and the multiplicity of bio-oil-coated plastic particles in an aqueous solution to yield a mixture including a multiplicity of biochar-coated plastic particles, and separating the multiplicity of biochar-coated plastic particles from the mixture to yield a multiplicity of treated plastic particles.

Implementations of the first general aspect may include one or more of the following features.

In some implementations, the multiplicity of plastic particles includes polyethylene terephthalate, polyethylene terephthalate glycol, polyurethane, or a combination thereof. In some cases, a mass ratio of the multiplicity of plastic particles to waste bio-oil is about 1:1. The first general aspect can further include soaking the multiplicity of plastic particles in the waste bio-oil for about 12 hours. In some implementations, the first general aspect further includes after the soaking, irradiating the multiplicity of plastic particles in the waste bio-oil for a first time for about 5 minutes. In some cases, the first general aspect further includes after the irradiating for the first time, stirring the multiplicity of plastic particles in the waste bio-oil for about 10 minutes. In certain cases, the first general aspect further includes after the stirring, irradiating the multiplicity of plastic particles in the waste bio-oil for a second time for about 5 minutes. The first general aspect can further include, after the irradiating for the second time, cooling the multiplicity of plastic particles in the waste bio-oil for about 2 hours.

In some cases, the first general aspect further includes grinding, rinsing, drying, and sieving the multiplicity of bio-oil-coated plastic particles to remove excess waste bio-oil from the multiplicity of bio-oil-coated plastic particles. In some implementations, rinsing the multiplicity of bio-oil-coated plastic particles includes washing with acetone. A temperature during the drying of the multiplicity of bio-oil-coated plastic particles can be about 60° C. In some cases, drying the multiplicity of bio-oil-coated plastic particles includes heating for about 15 minutes. In certain cases, sieving the multiplicity of bio-oil-coated plastic particles includes passing through a first sieve with openings of about 0.6 mm and a second sieve with openings of about 0.3 mm. A mass ratio of the multiplicity of bio-oil-coated plastic particles to biochar can be about 2:1. In some implementations, the aqueous solution includes acetone and water and a ratio of acetone to water is about 60:40. The first general aspect can further include stirring the mixture for about 10 minutes.

A second general aspect includes a multiplicity of biochar-coated plastic particles formed according to the first general aspect.

In a third general aspect, treating wastewater includes contacting the multiplicity of biochar-coated plastic particles formed by the method of the first general aspect with wastewater including metal ions; and adsorbing the metal ions onto the multiplicity of biochar-coated plastic particles, thereby reducing a concentration of the metal ions in the wastewater.

Implementations of the third general aspect may include one or more of the following features.

In some cases, the wastewater includes organic pollutants, dyes, and metal ions. In certain cases, the metal ions include mercury, nickel, lead, chromium, iron, copper, cadmium, zinc, or a combination thereof.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1A is a flow chart showing operations in an example process for treating plastic particles. FIG. 1B is a biochar molecular model and its electrostatic potential molecular surface map.

FIG. 2A shows ultraviolet-visible (UV-Vis) absorption spectra of eluents collected after filtering metal-treated samples of sand, glass beads, and carbon-coated oil-treated plastic granules (C-OTPG), following treatment with 0.25 mM FeSO₄·7H₂O. FIG. 2B shows UV-Vis absorption spectra of eluents collected after filtering metal-treated samples of sand, glass beads, and carbon-coated oil-treated plastic granules, following treatment with 0.25 mM CuSO₄·5H₂O.

### DETAILED DESCRIPTION

This disclosure describes the use of biochar-coated plastic granules to remove and immobilize metal ions (e.g., mercury, nickel, lead, chromium, iron, copper, cadmium, zinc, or a combination thereof) from various contaminated water sources. The combination of biochar's adsorption capabilities and the structural support provided by plastic granules offers a treatment for contaminated water sources, emphasizing both environmental remediation and resource conservation.

In an example, the adsorption performance of carbon-coated oil-treated plastic granules, sand, and glass beads were assessed in solutions containing Fe²⁺ and Cu²⁺ ions. Coated oil-treated plastic granules show comparable adsorption to sand and glass beads based on the continuous-flow test results. Ultraviolet-visible (UV-Vis) absorption spectra reveal that carbon-coated oil-treated plastic granules exhibit higher affinity for both Fe²⁺ and Cu²⁺ ions. Carbon-coated oil-treated plastic granules demonstrate a preference for Cu²⁺ over Fe²⁺, with a high adsorption capacity for Cu²⁺ across assessment conditions. The adsorption of Fe²⁺ is higher than that observed for sand and glass beads, highlighting the enhanced metal-adsorption of carbon-coated oil-treated plastic granules. Density functional theory analysis suggests that biochar's surface functional groups, including oxygen- and nitrogen-containing groups, serve as active sites for metal adsorption. These functional groups can facilitate complexation and ion-exchange mechanisms, enhancing biochar's metal-ion adsorption capabilities. Results suggest a stronger affinity of carbon-coated oil-treated plastic granules for Cu²⁺ ions when compared to Fe²⁺ ions.

This affinity can be due at least in part to the higher electronegativity of copper and its ability to form stable surface complexes with biochar's functional groups in pH conditions that are neutral to basic. The polyaromatic structure of biochar can support cation-π interactions, which contribute to the adsorption of metal ions. Density functional theory calculated adsorption energies suggest that Cu²⁺ can form stable interactions with biochar's regions that are rich in π electrons, underscoring biochar's selective affinity for Cu²⁺ over Fe²⁺.

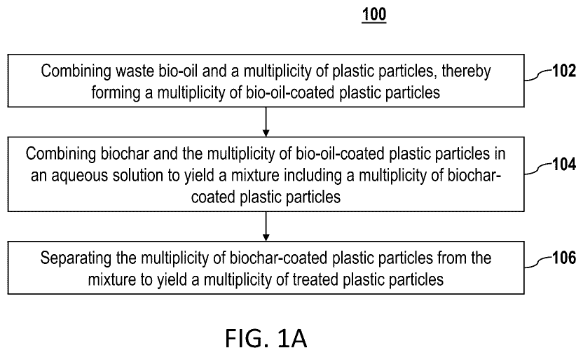

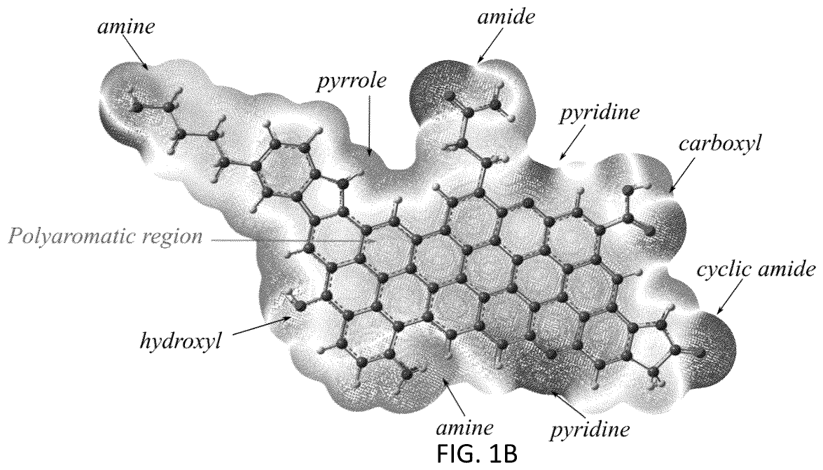

FIG. 1A is a flow chart showing operations in an example process 100 for treating plastic particles. In 102, waste bio-oil and a multiplicity of plastic particles are combined, thereby forming a multiplicity of bio-oil-coated plastic particles. In some examples, a mass ratio of the multiplicity of plastic particles to waste bio-oil is about 1:1. In 104, biochar and the multiplicity of bio-oil-coated plastic particles are combined in an aqueous solution to yield a mixture including a multiplicity of biochar-coated plastic particles. In some examples, a mass ratio of the multiplicity of bio-oil-coated plastic particles to biochar is about 2:1. In certain implementations, the aqueous solution includes acetone and water. In some cases, a ratio of acetone to water is about 60:40. Some implementations include stirring the mixture for about 10 minutes. In 106, the multiplicity of biochar-coated plastic particles are separated from the mixture to yield a multiplicity of treated plastic particles.

Suitable examples of the multiplicity of plastic particles include polyethylene terephthalate, polyethylene terephthalate glycol, polyurethane, or a combination thereof. Some implementations of the process 100 further includes soaking the multiplicity of plastic particles in the waste bio-oil for about 12 hours. After the soaking, the multiplicity of plastic particles are irradiated in the waste bio-oil for a first time for about 5 minutes. After irradiating for the first time, the multiplicity of plastic particles are stirred in the waste bio-oil for about 10 minutes. After stirring, the multiplicity of plastic particles are irradiated in the waste bio-oil for a second time for about 5 minutes. After irradiating for the second time, the multiplicity of plastic particles in the waste bio-oil are cooled for about 2 hours.

The process 100 further includes grinding, rinsing, drying, and sieving the multiplicity of bio-oil-coated plastic particles to remove excess waste bio-oil from the multiplicity of bio-oil coated plastic particles. In some examples, rinsing the multiplicity of bio-oil-coated plastic particles includes washing with acetone. A temperature during the drying of the multiplicity of bio-oil-coated plastic particles can be about 60° C. In some cases, drying the multiplicity of bio-oil-coated plastic particles include heating for about 15 minutes. Sieving the multiplicity of bio-oil-coated plastic particles can include passing through a first sieve with openings of about 0.6 mm and a second sieve with openings of about 0.3 mm.

Wastewater can be treated by contacting the multiplicity of biochar-coated plastic particles formed by process 100 with wastewater including metal ions and adsorbing the metal ions onto the multiplicity of biochar-coated plastic particles, thereby reducing a concentration of the metal ions in the wastewater. Wastewater can include organic pollutants, dyes, and metal ions. Suitable examples of metal ions include mercury, nickel, lead, chromium, iron, copper, cadmium, zinc, or a combination thereof.

In some cases, a solution including metal ions can be treated by contacting the multiplicity of biochar-coated plastic particles formed by process 100, thereby reducing a concentration of metal ions in the solution. The solution can include chloride ions. Suitable examples of metal ions include calcium, magnesium, aluminum, cobalt, copper, iron, manganese, nickel, zinc, or a combination thereof.

### EXAMPLES

Sand, glass beads, and carbon-coated oil-treated plastic granules were used as adsorption substrates. F-60 Ottawa sand (a quartz sand with SiO₂>98% and D₅₀=0.23 mm) was sourced from US Silica. Soda lime glass beads (uncoated, 1-1.3 mm, SiO₂≈72.3%, Na₂O≈13.3%, CaO≈8.9%, MgO≈4%) were obtained from Propper Manufacturing Company, Inc. Quartz sand and glass beads were evaluated as baseline materials to compare against the adsorption behavior of carbon-coated oil-treated plastic granules. Quartz sand was used in geo-environmental adsorption studies. Glass beads, with their smooth surface, served as a control to assess the impact of surface roughness and porosity on adsorption. All reagents used were reagent grade and no further purification was performed. High performance liquid chromatography (HPLC)-grade acetonitrile and water were obtained from Fisher Chemicals. FeSO₄·7H₂O and CuSO₄·5H₂O were purchased from Sigma-Aldrich and Oakwood Chemicals, respectively. pH-indicator strips were acquired from Merck. 0.20 μm syringe filters were sourced from Corning Inc.

To synthesize carbon-coated oil-treated plastic granules, polyethylene terephthalate particles were combined with waste bio-oil (e.g., waste vegetable oil) in a 1:1 mass ratio. Bio-oil is derived from conversion of biomass while waste bio-oil is derived from waste organic materials (e.g., agricultural residues, food waste, municipal solid waste, or waste oils). The mixture of polyethylene terephthalate particles and waste vegetable oil was conditioned and left to soak for 12 hours. The functionalization of plastic particles with bio-oil molecules was achieved using a two-step microwave irradiation process at 400 watts for a total of 10 minutes. Initially, the mixture was subjected to 5 minutes of irradiation, followed by a 10-minute stirring period outside the microwave. The second 5-minute irradiation was performed, and the mixture was left to cool for 2 hours at room temperature. To remove excess bio-oil, the product was ground, rinsed with acetone, and dried in an oven at 60° C. for 15 minutes. The treated plastic granules were sieved using a #30 sieve (with openings of 0.595 mm) and retained on a #50 sieve (with openings of 0.297 mm). Next, to coat the oil-treated plastic granules with biochar, a 1:2 mass ratio of biochar to oil-treated plastic granules was dispersed in a 60:40 acetone:water solution and stirred for 10 minutes. Using an ultrasonic cleaner, the mixture was sonicated at 50° C. for 15 minutes. After 24 hours of settling at room temperature, a second sonication was performed for 90 minutes, and the final product was dried and sieved.

Testing columns of absorbent materials were prepared by compacting 45 g of each solid absorbent into 20-mL syringes. Four sets of testing columns were prepared: (I) column filled with sand; (II) column filled with glass beads; (III) column filled with 1.75 g of plastic granules positioned between a bottom layer of 35 g of washed sand and a top layer of 8.25 g of the same sand; and (IV) column filled with 1.75 g of carbon-coated oil-treated plastic granules positioned between a bottom layer of 35 g of washed glass beads and a top layer of 8.25 g of the same glass beads. The sand and glass beads were pre-washed by soaking in 1 L of deionized water overnight to remove soluble salts and minerals.

Each set of testing columns included three columns: one fed with an Fe²⁺ solution, one fed with a Cu²⁺ solution, and one fed with deionized water as a control. The metal-ion solutions were prepared by dissolving 20 mg of FeSO₄ or CuSO₄ in 1 L of deionized water and diluting this solution fivefold to achieve a final concentration of 4 mg/L. During the assessment, 100 mL of each solution was circulated through the syringes at a flow rate of 1.8 mL/min for one hour. This volume exceeded the pore volume of the solid adsorbents by a factor of six. The continuous flow with the chosen rate allowed the solids to reach saturation and were fully exposed to the solution, maintaining a dynamic interaction between the metal solution and the adsorbent, maximizing contact efficiency, and preventing uneven adsorption. The pH values of the effluents from each column were measured at intervals throughout the assessment. Upon completion, the final effluent samples were collected and analyzed for ionic composition using inductively coupled plasma atomic emission spectroscopy.

Heidolph stirrer plates (Hei-PLATE Mix ‘n’ Heat Core+) were used to stir the samples at room temperature at 1000 rpm. Ultraviolet-visible (UV-vis) absorbance spectra were collected on a Shimadzu ultraviolet-visible-near infrared (UV-vis-NIR) 3600 spectrophotometer with a quartz cuvette (1 cm path length) across the range of 200 nm to 700 nm.

To assess the adsorption capacity of sand, glass beads, and carbon-coated oil-treated plastic granules for Fe²⁺ and Cu²⁺ ions, each sample was exposed to metal-ion solutions in water, allowing adsorption on the sample surfaces. 1 g of each sample (sand, glass beads, or carbon-coated oil-treated plastic granules) was weighed into individual 20 mL scintillation vials. A stock solution of metal ions (0.50 mM) was prepared by dissolving Fe²⁺ and Cu²⁺ salts in 20 mL of water. 5 mL of this stock solution was added to each vial, creating a 0.25 mM final concentration in each sample. The pH of each solution was measured with Merck MColorpHast non-bleeding pH-indicator strips (1.09535.0001) and found to be 5. The vials were capped with polyethylene lids and stirred at room temperature using a polytetrafluoroethylene-coated magnetic stir bar (VWR, egg-shaped, 15×6 mm, 58949-010) for 48 hours. 1 mL of solution was withdrawn from each vial, filtered using a 0.20-μm-pore polyethersulfone membrane syringe filter (Corning® 28-mm diameter, 431229), and placed in separate vials for analysis. The concentration of metal ions in the filtrate was measured to determine the amount of metal adsorbed onto each sample. FeSO₄·7H₂O and CuSO₄·5H₂O were assessed with the three materials, and each assessment was conducted in triplicate.

Samples prepared for UV-Vis analysis were diluted with acetonitrile and analyzed over a wavelength range of 200 nm to 700 nm. Calibration plots were generated using known concentrations of FeSO₄·7H₂O and CuSO₄·5H₂O, with changes in absorption spectra recorded at each concentration. To prepare calibration solutions, 0.5 mM stock solutions of each metal salt were made in deionized water, and small volumes were incrementally added to a quartz cuvette containing 2 mL of acetonitrile, noting the corresponding spectral shifts. These observations were used to create a calibration curve. For sample analysis, 500 μL of the filtrate from the adsorption assessments was added to a quartz cuvette with 2 mL of acetonitrile and analyzed spectrophotometrically. The calibration curve was applied to determine the concentration of metal ions in the treated samples.

Effluent samples from each column were analyzed for Fe²⁺ and Cu²⁺ content using inductively coupled plasma atomic emission spectroscopy. After filtration to remove particulates, standard solutions of Fe²⁺ and Cu²⁺ were prepared to calibrate the instrument. The samples were introduced into an argon plasma, where the ions were excited, emitting light at specific wavelengths characteristic of each metal. The intensity of the emitted light was measured to determine the concentrations of the metal ions. Calibration curves were constructed to ensure accuracy of the measurements, with blank samples included for quality control.

The interactions between heavy metals and plastic granules coated with biochar were assessed by a molecular model representing the biochar surface. This model can identify the mechanisms behind selective adsorption by the biochar layer on the plastic granules. As shown in Table 1, the elemental composition of biochar was provided by the model. The model incorporates biochar's features of a carbonaceous framework and active surface functional groups to provide insight into how the biochar coating on plastic granules can enhance its affinity for heavy metals.

TABLE 1
Elemental analysis of biochar
Elemental analysis (wt %)

| C | H | N | O |
|---|---|---|---|
| 41.5 ± 0.41 | 3.99 ± 0.14 | 4.18 ± 0.19 | 50.33 ± 1.14 |

XRD peaks at 26.426° and 43.019° (2θ) signal the presence of graphite-like carbon in biochar derived from biomass through hydrothermal liquefaction. The process, conducted at temperatures between 300° C. and 350° C., suggests the formation of disordered polyaromatic clusters in the biochar structure.

Reference Fourier transform infrared spectroscopy (FTIR) data on chemical bonds and atomic ratios was used in developing the biochar model. The high nitrogen content of feedstock can contribute to an increase in nitrogen functional groups in the biochar. Additionally, the carbohydrate content can aid nitrogen retention during the thermochemical conversion of biomass. Nitrogen functional groups and oxygen-based groups, including carbonyl, ketene, phenol, and carboxyl, on the surface of biochar, can be identified using FTIR peak data. N—H stretching peaks appear in the 1600-1670 cm⁻¹ range, with minor peaks between 2100-2270 cm⁻¹, suggesting the presence of amides and ketones. Using FTIR, the functional groups surrounding the polyaromatic core, which can aid in the biochar's adsorption properties, were identified. All nitrogen functional groups in the molecular schematic of the biochar structure are shown in FIG. 1B. Nitrogen functional groups can aid in understanding heavy-metal adsorption mechanisms and their role in selective adsorption.

The adsorption of heavy metals onto biochar was assessed, focusing on the interactions between the biochar surface and metals such as copper and iron. Through computational modeling, the biochar's capabilities for metal adsorption were assessed. The DMol³ module in the Accelrys Materials Studio software was used to optimize the structure of biochar and the metal-biochar complexes formed upon adsorption. To identify the active sites participating in metal adsorption and evaluate the thermodynamic stability of these complexes, long-range van der Waals and electrostatic interactions were included. Specifically, Grimme's long-range dispersion correction was applied to the Perdew-Burke-Ernzerhof (PBE) functional within the generalized gradient approximation known as PBE-D. Optimization uses all-electron double-numerical basis sets with polarization functions, and calculations were performed at the “Fine” integration level. Convergence tolerances were set at 1.0×10⁻⁵ Hartree for energy, 2.0×10⁻³ Hartree/Å for maximum force, and 5.0×10⁻³ Å for displacement, ensuring high precision in evaluating biochar's adsorption potential for heavy metals.

Several possible mechanisms of metal adsorption onto biochar were considered. For each adsorption complex formed between biochar and a heavy metal, thermodynamic stability was assessed by calculating the adsorption or binding energy (E_{ads}). This energy, defined as the difference between the total energy of the adsorbed complex and the sum of the energies of the individual components in their isolated states, is represented in Equation 1.

$${E}_{a d s} = {E}_{C o m p l e x} - ( {E}_{metal} + {E}_{b i o c h a r} ) \qquad ( 1 )$$

Here, E_{complex} is the total energy when the biochar and metal ion are in an adsorbed state, while Eₘₑₜₐₗ and E_{biochar} represent the energies of the isolated metal ion and biochar, respectively, at equilibrium. A negative adsorption energy indicates that the adsorbed state is energetically favorable, thus confirming the thermodynamic viability of the adsorption process. Furthermore, a more negative value of adsorption energy suggests a stronger interaction between the biochar and the metal ion.

To assess how biochar interacts with metal ions, calculations were used to map the electrostatic potential across the biochar's van der Waals surface. These electrostatic potential maps reveal areas of positive and negative potential, identifying possible binding sites for metal ions. Using the optimized biochar structure, wave-function files were generated at the PBE/6-31G* level through Gaussian 16 and calculated electrostatic potential values with the Multiwfn program. The resulting electrostatic potential surfaces were visualized using the Visual Molecular Dynamics program, highlighting potential ion-binding regions.

The electrostatic potential maps show a pronounced molecular polarity in biochar, due at least in part to the presence of nitrogen-bearing functional groups. This polarity can enhance the non-covalent interactions between biochar and metal ions, emphasizing the role of nitrogen groups in capturing and immobilizing metals to reduce leaching. The electron-dense regions, containing donor atoms, emerge as possible sites for binding positively charged metal ions.

The results of the adsorption assessments, presented in Table 2, show that sand and glass bead columns combined with carbon-coated oil-treated plastic granules exhibit adsorption capacities that can be comparable to columns containing only sand or glass beads. The columns with sand displayed slightly higher adsorption, due at least in part to sand's microscale surface roughness and its lower isoelectric point. Quartz can have an isoelectric point around pH 2-3, and uncoated soda lime glass beads have an isoelectric point around pH 5. Given the pH range of 5.5 to 9.5, sand surfaces can carry more negative charges than glass beads, resulting in greater cation adsorption at least in part because of the higher density of surface charge.

TABLE 2
Adsorption assessment results based
on the continuous-flow assessment

| | | Metal Conc. | |
|---|---|---|---|
| | Metal Ion | in Effluent | Adsorption |
| Adsorbent | Solution | (ppm) | (%) |
| Sand | Fe²⁺ | 0.092 | 87.5 |
| | Cu²⁺ | 0.037 | 95.4 |
| | Deionized | [Cu] = 0.000 | — |
| | water | [Fe] = 0.000 | — |
| Glass Beads | Fe²⁺ | 0.209 | 71.6 |
| | Cu²⁺ | 0.036 | 95.5 |
| | Deionized | [Cu] = 0.000 | — |
| | water | [Fe] = 0.000 | |
| Sand + carbon- | Fe²⁺ | 0.189 | 74.4 |
| coated | Cu²⁺ | 0.061 | 92.4 |
| oil-treated | Deionized | [Cu] = 0.000 | — |
| plastic granules | water | [Fe] = 0.001 | |
| Glass Beads + | Fe²⁺ | 0.232 | 68.5 |
| carbon-coated | Cu²⁺ | 0.094 | 88.3 |
| oil-treated | Deionized | [Cu] = 0.000 | — |
| plastic granules | water | [Fe] = 0.001 | |

Cu²⁺ adsorption is higher than Fe²⁺ adsorption across the samples. This trend can be explained by several factors. For example, Cu²⁺ can form stronger interactions with surfaces than Fe²⁺ at least in part because Cu²⁺ has higher hydration energy. Cu²⁺ also has greater electronegativity than Fe²⁺, which can enable stronger bonding with negatively charged surfaces, such as quartz or soda lime glass. Fe²⁺ has a larger hydration shell, which can be more challenging to break. This can result in lower adsorption efficiency compared to Cu²⁺, which can more readily interact with surface sites. Cu²⁺ also forms more stable surface complexes with oxygen-containing functional groups (e.g., silanol groups on quartz and glass surfaces) than Fe²⁺. Under pH conditions that are neutral to basic, these groups are more negatively charged and can facilitate Cu²⁺ adsorption. Fe²⁺ is susceptible to oxidation to Fe³⁺ in the presence of oxygen, particularly at pH conditions that are neutral to basic, leading to the formation of iron hydroxides or oxides. This process can result in precipitation before adsorption, reducing the amount of Fe²⁺ available for surface interaction. By contrast, Cu²⁺ can be less prone to precipitation under typical environmental conditions, making it more available for adsorption.

Pristine samples lack a characteristic UV-Vis absorption profile, as there are negligible detectable electronic transitions resulting from interactions between the functional groups on their surfaces and metal salts. Consequently, metal-ion adsorption was assessed indirectly by measuring the concentration difference of metal ions in the metal-containing water before and after treatment with the adsorbents.

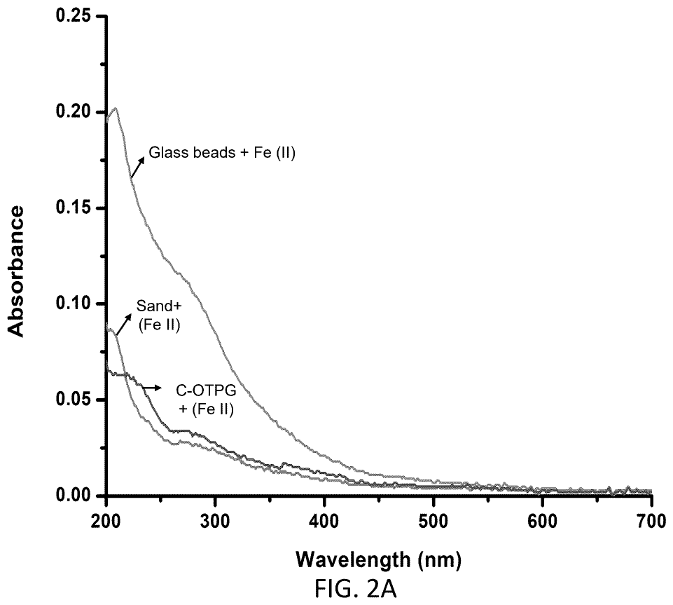

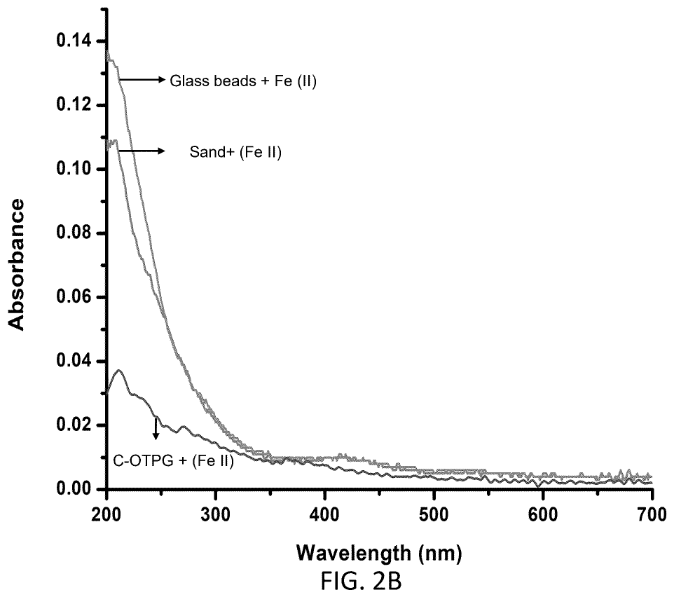

After exposing the pristine samples to known concentrations of FeSO₄·7H₂O and CuSO₄·5H₂O in water and filtering through syringe filters, the resulting eluents were collected and analyzed spectroscopically. Calibration plots for FeSO₄·7H₂O and CuSO₄·5H₂O were first established by diluting the metal solutions in acetonitrile. From these linear fit plots, the calibration equations were obtained for FeSO₄·7H₂O and CuSO₄·5H₂O. The equations were used to determine the concentration of each respective metal ion in the eluent. FIGS. 2A and 2B shows the UV-Vis absorption spectra of the eluents collected after filtering the pristine sand, glass beads, and carbon-coated oil-treated plastic granules samples with 0.25 mM FeSO₄·7H₂O and CuSO₄·5H₂O solutions.

From the absorption spectra, the concentration of metal ions in the eluent was calculated using the linear fit equations derived from the calibration plots. As shown in FIGS. 2A and 2B, the results indicated that the samples displayed a higher affinity for Cu²⁺ ions than for Fe²⁺ ions in water. Table 3 summarizes the percentage adsorption (with error bars) of each metal ion across various samples. Among the three types, carbon-coated oil-treated plastic granules exhibited the highest affinity for both iron and copper, with a preference for Cu²⁺ over Fe²⁺. The adsorption capacity of carbon-coated oil-treated plastic granules for Cu²⁺ is comparable across all conditions. For Fe²⁺ adsorption, carbon-coated oil-treated plastic granules showed a higher adsorption capacity than both sand and glass beads.

TABLE 3
Percentage adsorption of Fe²⁺ and Cu²⁺ ions by sand, glass
beads, and carbon-coated oil-treated plastic granules samples

| entry | adsorbent | Fe²⁺ adsorption (%) | Cu²⁺ adsorption (%) |
|---|---|---|---|
| 1 | sand | 33 ± 24 | 88 ± 03 |
| 2 | glass beads | 30 ± 12 | 87 ± 02 |
| 3 | C-OTPG | 56 ± 13 | 87 ± 03 |

The effectiveness of biochar in binding heavy metals can arise from its structural and chemical properties, including high surface area, porosity, diverse functional groups, and cation-exchange capacity. These attributes can create a multifunctional platform for metal-ion adsorption through a range of physical and chemical pathways. Biochar's adsorption mechanisms can be complexation, ion exchange, electrostatic interactions, and physical adsorption, each influenced by biochar's specific surface characteristics.

On the biochar surface, functional groups can provide active binding sites that facilitate the adsorption of metal ions, such as Fe²⁺ and Cu²⁺, through several mechanisms. Electrostatic potential analysis of the biochar molecular model can be used to identify adsorption sites for metal ions. The analysis can highlight regions with high electron density, which can be ideal for metal-ion interactions. Functional groups such as pyridine and amine that displayed more electron density were selected for comparison of their role in metal-ion adsorption, leveraging their potential for interaction through mechanisms such as ion exchange and complexation.

In complexation, the metal ions can engage in coordinate bonding with oxygen atoms on the biochar. In this bonding, protons can be replaced, leading to the formation of stable metal-organic compounds (e.g., carboxylates and hydroxides) while releasing H⁺ ions into the solution. Through ion exchange, biochar-bound ions can be substituted by metal ions from the surrounding solution. Electrostatic interactions occur between positively charged metal ions and negatively charged sites on the biochar surface, such as carboxylate groups, creating ion-dipole attractions. Physical adsorption, driven by van der Waals forces and cation-π interactions, can occur on the polyaromatic surfaces of biochar. These adsorption processes are dependent on the presence and density of functional groups on the biochar surface. Environmental factors, particularly pH, can play a role by modifying the charge and protonation of these groups, thus impacting their interactions with metal ions and influencing the efficiency of adsorption.

To assess the selective adsorption of Fe²⁺ and Cu²⁺ ions on biochar, density functional theory calculations were applied, creating models to represent the biochar's functional groups participating in metal binding as shown in FIG. 1B. Geometry optimizations were performed for each metal-biochar combination to determine the most energetically stable structures, from which adsorption energies were derived. These energies, calculated as the difference between the energy of the optimized metal-biochar complex and the sum of the isolated energies of biochar and the respective metal ion (Equation 1), provide insight into each metal's interaction strength with the biochar surface. This analysis can help identify the adsorption mechanism for each ion by examining the electronic structure surrounding the active sites. An ion with a more negative adsorption energy indicates a stronger interaction and a higher affinity for the biochar.

To compare the intrinsic binding strengths of biochar for Fe²⁺ and Cu²⁺, density functional theory analysis was performed. The results offer insight into biochar's selectivity and adsorption potential, providing biochar's suitability for heavy-metal remediation in wastewater treatment. Understanding this selectivity can inform how biochar can behave in complex environments. Selective adsorption can impact the efficiency of metal removal in various wastewater contexts ranging from industrial effluents to landfill leachate.

Two mechanisms were used to assess how biochar's properties can facilitate the adsorption of Fe²⁺ and Cu²⁺ ions. The two mechanisms were ion exchange and complexation. During the pyrolysis of biomass, organic matter is carbonized, leaving behind mineral-rich ash composed of base cations such as potassium, calcium, magnesium, and sodium. The specific mineral content in biochar can depend on the original feedstock's composition and the parameters of pyrolysis, such as temperature and duration. As biomass naturally accumulates minerals, biochar derived from biomass provides a matrix for metal adsorption, retaining base cations within its structure.

Biochar's base cations play a role in heavy-metal immobilization, primarily through an ion exchange mechanism in which metal ions from the surrounding solution replace the biochar's inherent cations. This exchange process not only absorbs heavy metals but also neutralizes the biochar's surface charge, shifting the point of zero charge and expanding the pH range at which biochar can adsorb positively charged ions. Potassium ions in biochar can interact with heavy metals via electrostatic forces and complexation at surface functional groups. The density functional theory analysis examines the displacement of K⁺ by Fe²⁺ and Cu²⁺ ions on biochar's active sites, with a focus on both oxygen- and nitrogen-containing functional groups that facilitate ion exchange and complexation.

To assess ion exchange, gas-phase density functional theory calculations were used to compare the relative adsorption energies of Fe²⁺ and Cu²⁺ ions compared to K⁺, using the optimized biochar structure. The adsorption energies obtained for Cu²⁺ (−552.0 kcal/mol) and Fe²⁺ (−529.69 kcal/mol) were more negative than the energy for K⁺ adsorption (−121.8 kcal/mol) on the same —COO⁻ site of the biochar. These values indicate that biochar interacts more favorably with heavy-metal ions (e.g., Cu²⁺) than with biochar's inherent K⁺ ions, suggesting that heavy-metal ions can effectively displace K⁺ in the biochar matrix.

The contribution of nitrogen-based functional groups (such as amines, amides, and pyridines) to the ion-exchange process was also assessed. These groups, with their electron-dense nitrogen atoms, can facilitate adsorption by exchanging biochar-bound cations, such as K⁺, Na⁺, or Ca²⁺, with heavy metals. Density functional theory results show that Cu²⁺ and Fe²⁺ ions have stronger interactions with nitrogen-containing groups than with inherent K⁺ ions, suggesting their active role in the ion-exchange mechanism. For instance, Cu²⁺ exhibited a higher interaction energy with the nitrogen-dense pyridine group (−451.5 kcal/mol) compared to K⁺, underscoring the effectiveness of nitrogen sites in biochar for capturing heavy-metal ions. These interaction energies highlight the role of nitrogen-containing groups in enhancing the adsorption capacity of biochar for heavy metals.

In addition to ion exchange, density functional theory calculations can provide insight into complexation mechanisms, whereby biochar's functional groups form stable complexes with Fe²⁺ and Cu²⁺ ions. The carboxylic and hydroxyl groups in biochar, particularly when deprotonated in alkaline conditions, exhibit negative charges that enhance interactions with positively charged metal ions through complexation. Nitrogen-based functional groups (including amines, amides, and pyridines) along with carbonyl groups can also contribute to this process due at least in part to their electron-donating characteristics. These functional groups, having lone pairs on nitrogen or oxygen atoms, can create strong, stable complexes with heavy metals, reinforcing biochar's capacity for heavy-metal immobilization.

Density functional theory results and molecular modeling indicate that nitrogen-containing groups are efficient at binding Cu²⁺ and Fe²⁺, due at least in part to their inherent basicity and strong electron-donating properties. This suggests a selectivity order of Cu²⁺>Fe²⁺ for nitrogen-based adsorption sites, underscoring the role of nitrogen functionalities in enhancing the adsorption potential of biochar. Overall, the combined presence of oxygen- and nitrogen-containing functional groups on biochar can produce a synergistic effect, enhancing the material's capacity for heavy-metal sequestration through both ion exchange and complexation. This versatility demonstrates biochar's potential as an adsorbent for applications in wastewater treatment across diverse settings.

Density functional theory analysis highlights cation-π interactions as a mechanism for Fe²⁺ and Cu²⁺ adsorption onto biochar, partially driven by the π-rich polyaromatic structure inherent in the biochar matrix. The polyaromatic regions in biochar create zones of concentrated electron density (e.g., pyridine), as delocalized π electrons circulate above and below the molecular plane. This electron-rich environment can allow for the stabilization of positively charged metal ions through cation-π interactions, where the attraction arises from the electrostatic forces between the metal cations and these π electron clouds. By acting as electron-dense sites, these polyaromatic segments of biochar can effectively bind and stabilize Fe²⁺ and Cu²⁺ ions via cation-π interactions, facilitating enhanced adsorption.

As shown in FIG. 1B, the electrostatic potential analysis reveals that these polyaromatic zones in biochar contain regions of low electrostatic potential, making them suitable as π-donor sites for metal cations. Density functional theory energy results for Fe²⁺ and Cu²⁺ adsorption via cation-π interactions illustrate these dynamics: the adsorption energy for Cu²⁺ was calculated to be −414.9 kcal/mol, and Fe²⁺ showed an adsorption energy of −407.8 kcal/mol. These negative values can indicate a strong affinity of these metal ions for the polyaromatic regions, with Cu²⁺ displaying the most favorable interaction.

The observed trend in adsorption energy —Cu²⁺>Fe²⁺— can be linked to factors such as ionic radius, charge density, and electronic configuration. Cu²⁺, with its partially filled d orbitals (3d⁹), has an ability to form stable cation-π complexes, a trait that Fe²⁺ shares to a lesser extent. This arises at least in part because both Cu²⁺ and Fe²⁺ can engage in π-backbonding with the π electron cloud in the biochar, a phenomenon where the metal ion not only attracts electrons from the π system but also returns electron density into its anti-bonding orbitals (π*). This electron back-donation enhances the stability and strength of the cation-π bond. The interaction of Cu²⁺ with the polyaromatic system is further influenced by its electronic configuration and optimal size, which allow it to form stable multicenter cation-π interactions. The molecular modeling results suggest that Fe²⁺ tends to position itself above individual benzene rings in the biochar's polyaromatic structure, whereas Cu²⁺ often situates itself at the junction of multiple benzene rings, leveraging its size and configuration to maximize its interaction with π electrons from several rings at once. This multicenter interaction highlights the stronger binding affinity of Cu²⁺.

These findings suggest cation-π interactions as a selective pathway for metal adsorption by biochar, for metals such as Cu²⁺ that are well-suited to engage in multicenter binding. The selective adsorption behavior observed can enhance biochar's utility in wastewater-treatment applications, with the polyaromatic structure providing a stable and versatile platform for heavy-metal immobilization.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method of treating plastic particles, the method comprising:
combining waste bio-oil and a multiplicity of plastic particles, thereby forming a multiplicity of bio-oil-coated plastic particles;
combining biochar and the multiplicity of bio-oil-coated plastic particles in an aqueous solution to yield a mixture comprising a multiplicity of biochar-coated plastic particles; and
separating the multiplicity of biochar-coated plastic particles from the mixture to yield a multiplicity of treated plastic particles.

2. The method of claim 1, wherein the multiplicity of plastic particles comprises polyethylene terephthalate, polyethylene terephthalate glycol, polyurethane, or a combination thereof.

3. The method of claim 1, wherein a mass ratio of the multiplicity of plastic particles to waste bio-oil is about 1:1.

4. The method of claim 1, further comprising soaking the multiplicity of plastic particles in the waste bio-oil for about 12 hours.

5. The method of claim 4, further comprising, after the soaking, irradiating the multiplicity of plastic particles in the waste bio-oil for a first time for about 5 minutes.

6. The method of claim 5, further comprising, after the irradiating for the first time, stirring the multiplicity of plastic particles in the waste bio-oil for about 10 minutes.

7. The method of claim 6, further comprising, after the stirring, irradiating the multiplicity of plastic particles in the waste bio-oil for a second time for about 5 minutes.

8. The method of claim 7, further comprising, after the irradiating for the second time, cooling the multiplicity of plastic particles in the waste bio-oil for about 2 hours.

9. The method of claim 1, further comprising grinding, rinsing, drying, and sieving the multiplicity of bio-oil-coated plastic particles to remove excess waste bio-oil from the multiplicity of bio-oil-coated plastic particles.

10. The method of claim 9, wherein rinsing the multiplicity of bio-oil-coated plastic particles comprises washing with acetone.

11. The method of claim 9, wherein a temperature during the drying of the multiplicity of bio-oil-coated plastic particles is about 60° C.

12. The method of claim 9, wherein drying the multiplicity of bio-oil-coated plastic particles comprises heating for about 15 minutes.

13. The method of claim 9, wherein sieving the multiplicity of bio-oil-coated plastic particles comprises passing through a first sieve with openings of about 0.6 mm and a second sieve with openings of about 0.3 mm.

14. The method of claim 1, wherein a mass ratio of the multiplicity of bio-oil-coated plastic particles to biochar is about 2:1.

15. The method of claim 1, wherein the aqueous solution comprises acetone and water and a ratio of acetone to water is about 60:40.

16. The method of claim 1, further comprising stirring the mixture for about 10 minutes.

17. A multiplicity of biochar-coated plastic particles formed by the method of claim 1.

18. A method of treating wastewater, the method comprising:
contacting the multiplicity of biochar-coated plastic particles formed by the method of claim 1 with wastewater comprising metal ions; and
adsorbing the metal ions onto the multiplicity of biochar-coated plastic particles, thereby reducing a concentration of the metal ions in the wastewater.

19. The method of claim 18, wherein the wastewater comprises organic pollutants, dyes, and metal ions.

20. The method of claim 18, wherein the metal ions comprise mercury, nickel, lead, chromium, iron, copper, cadmium, zinc, or a combination thereof.
